(19) United States
(12) Patent Application Publication
(10) Pub. No.: US 2024/0158071 A1
(43) Pub. Date: May 16, 2024

(54) AIRCRAFT WING

(71) Applicant: Airbus Operations Limited, Bristol (GB)

(72) Inventor: Thomas Wilson, Bristol (GB)

(21) Appl. No.: 18/378,925

(22) Filed: Oct. 11, 2023

(30) Foreign Application Priority Data
Nov. 16, 2022 (GB) 2217101.1

(51) Int. Cl. B64C 23/06; B64C 3/56

(52) U.S. Cl. CPC B64C 23/069; B64C 3/56

(57) ABSTRACT

An aircraft wing has a fixed wing and a moveable wing tip device. The wing is operable in a fixed flight configuration, in which the wing tip device is fixed relative to the fixed wing and the wing tip device is forward swept, and a moving flight configuration in which the wing tip device is free to move relative to the fixed wing. The forward moveable swept wing tip device may provide particular synergy with a forward swept fixed wing.

### TECHNICAL FIELD

The disclosure herein relates to an aircraft wing with a moveable wing tip device.

### BACKGROUND

On commercial airliner aircraft the wings are typically swept aft to delay the increase in drag associated with flight at Mach numbers approaching unity. The drag reducing effect of an aft swept wing can also be achieved by sweeping the wing forward.

Forward swept wings are known to have a number of benefits versus aft swept wings, including lower incremental load for a given induced drag (for a rigid wing), inboard rather than outboard stall, and laminar flow possible at high Mach numbers (which could avoid the need to slow down to achieve laminar flow).

However, the key reason why forward swept wings have not been pursued, except for a few US, Russian and German examples (e.g. X-29, Su-47, HFB 320 Hansa Jet), is static aeroelastic divergence—this is caused by the forward sweep creating a geometrical coupling between upwards wing bending and nose up wing twist, which becomes unstable at a certain dynamic pressure. Moreover, even if the divergence speed is not reached the wing loads and therefore wing weight are very significantly increased (“passive load amplification” versus “passive load alleviation” for aft swept wings).

### SUMMARY

A first aspect of the disclosure herein provides an aircraft wing for an aircraft having a longitudinal axis, the wing extending in a spanwise direction perpendicular to the aircraft longitudinal axis, wherein the wing comprises a fixed wing with a tip, and a wing tip device moveably mounted at the tip of the fixed wing, wherein the fixed wing has an upper surface and a lower surface, and the wing tip device has an upper surface, a lower surface and a leading edge, and the wing tip device is operable between: (i) a fixed flight configuration for use during flight, in which configuration the upper and lower surfaces of the wing tip device are substantially fixed relative to the upper and lower surfaces of the fixed wing, and wherein the leading edge of the wing tip device is forward swept with respect to the spanwise direction; and (ii) a moving flight configuration for use during flight, in which configuration the wing tip device is free to move relative to the fixed wing such that at least one of the upper and lower surfaces of the wing tip device is moved away from the respective surface of the fixed wing.

A further aspect of the disclosure herein provides a method of operating an aircraft wing for an aircraft having a longitudinal axis, the wing extending in a spanwise direction perpendicular to the aircraft longitudinal axis and comprising a fixed wing with a tip, and a wing tip device moveably mounted at the tip of the fixed wing, wherein the fixed wing has an upper surface and a lower surface, and the wing tip device has an upper surface, a lower surface and a leading edge, the method comprising the steps of: (a) placing the wing tip device in a fixed flight configuration during flight in which the upper and lower surfaces of the wing tip device are fixed with respect to the upper and lower surfaces of the fixed wing, and in which the leading edge of the wing tip device is forward swept with respect to the spanwise direction; and (b) placing the wing tip device in a moving flight configuration during flight, in which configuration the wing tip device is freely moveable relative to the fixed wing such that at least one of the upper and lower surfaces of the wing tip device is move away from the respective surface of the fixed wing.

The disclosure herein exploits the benefits of a folding wing tip device specifically for a forward swept wing tip device particularly, but not exclusively, for a forward swept fixed wing.

By releasing the wing tip device to be free to move relative to the fixed wing in the moving flight configuration, there is zero spanwise bending moment transferred from the wing tip device to the tip of the fixed wing. Therefore, the bending moment at the root of the fixed wing, i.e. the root bending moment, is reduced in the moving flight configuration compared to the fixed flight configuration.

Furthermore, for the wing tip device having a leading edge with a forward sweep angle, the effect of releasing the wing tip device to be freely moving and thus unloading the folding wing tip device will be to cause the fixed wing to twist relatively nose down.

Preferably, the aircraft wing further comprises a restraining assembly operable between a restraining mode in which the wing tip device is held in the fixed flight configuration using a restraining force, and a releasing mode in which the restraining force on the wing tip device is released, such that the wing tip device is able to adopt the moving flight configuration, and the wing tip device is entirely free to rotate when the restraining assembly is in the releasing mode.

The wing tip device can be securely held in the fixed flight configuration during normal cruise flight, but if the aircraft encounters gusts, or other high load events, the restraining force can be released such that the wing tip device is movable quickly to the moving flight configuration. This may mean the wing can avoid being subjected to high gust loadings. This in turn may enable the wing to have a relatively large span, without necessarily having to incur the associated weight penalty, because it can be designed for a lower magnitude of maximum load.

In addition to loads alleviation, the release of the folding wing tip to flap free would cause the aircraft to pitch down rather than up, which could open the possibility of releasing actively at low speed/altitude e.g. if high roll rate required (thanks to reduced roll damping from the flapping).

The default (passive) mode of the restraining assembly is preferably the restraining mode. The restraining assembly preferably needs activating, for example via an input signal, in order to switch to the releasing mode. This ensures an ‘active’ step will be required to move the restraining assembly to the releasing mode, thereby removing the risk of uncommanded actuation to the releasing mode.

The wing tip device may be entirely passively actuated in the moving flight configuration once the restraining assembly is in releasing mode. For example, the wing tip device may be moved under the action of aerodynamic forces and/or gravity. Having the restraining assembly in combination with this moving wing tip device may be referred to as a “semi-aeroelastic” arrangement.

The wing tip device may be entirely free to rotate when the restraining assembly is in the releasing mode (i.e. there may be substantially no other resistive forces acting to prevent rotation once the restraining force is removed). When the wing tip device is free to rotate in this manner, it may be referred to as ‘flapping’.

The fixed wing may have a leading edge, and the leading edge of the fixed wing may be forward swept with respect to the spanwise direction in the fixed flight configuration. For a forward swept wing, the forward sweep of the wing tip device has been found to have a beneficial combined effect on loads alleviation when released.

As mentioned above, the forward swept fixed wing displays static aeroelastic divergence —this is caused by the forward sweep creating a geometrical coupling between upwards wing bending and nose up wing twist, which becomes unstable at a certain dynamic pressure. When the forward swept wing tip device is released to the moving flight configuration, the absence of bending loads being transmitted from the wing tip device to the fixed wing means the static aeroelastic divergence speed will be delayed because the wing is effectively shortened.

Moreover, not only does the wing bending reduce (which causes a reduction in the nose up wing twist) but the effect of releasing the wing tip device to be freely moving and thus unloading the folding wing tip device will be to cause the fixed wing to twist relatively nose down. This further reduces wing bending on the fixed wing due to the geometrical coupling. In other words, for a forward swept fixed wing the aeroelastic efficiency of a (flapping) forward swept wing tip is greater than 100%, meaning the load alleviation benefit would be better than for a rigid wing or flexible aft swept wing with a flapping forward swept wing tip.

This combined effect of the flapping forward swept wing tip device on a forward swept fixed wing may delay the static aeroelastic divergence speed and significantly offset the bending loads and weight of the forward swept wing, thus allowing the aerodynamic benefits of a forward swept wing to be realized.

Preferably, the leading edge of the fixed wing has a sweep angle with respect to the spanwise direction, and the leading edge of the wing tip device has a sweep angle with respect to the spanwise direction, and the sweep angle of the fixed wing is the same as the sweep angle of the wing tip device adjacent the tip of the fixed wing.

Alternatively, the leading edge of the fixed wing may be aft swept with respect to the spanwise direction. With an aft swept fixed wing and a forward swept wing tip device, when the wing tip device is released there will still be a significant reduction in wing bending due to unloading of the wing tip device, and there will also be some relative nose down twist at the tip of the fixed wing. However, the degree of relative nose down twist due to release of the wing tip device will be lower than for a forward swept wing. The aeroelastic efficiency of the flapping wing tip is diminished for an aft swept wing, and this inefficiency may get worse at higher speeds.

Preferably, the wing tip device has a center of lift, and the tip of the fixed wing has a chord, and wherein the location of the center of lift is forward of the location of 50% chord of the tip of the fixed wing. Therefore, the center of lift creates a nose up twist at the tip of the fixed wing when the wing tip device is restrained in the fixed flight configuration, and this causes the relative nose down twist when the load on the wing tip device is diminished by releasing the wing tip device in the moving flight configuration.

The wing tip device may also be operable in (iii) a ground configuration for use during ground-based operations, in which ground configuration the wing tip device is moved away from the flight configuration such that the span of the aircraft wing is reduced, wherein the aircraft comprises an actuator arranged to move the wing tip device between the fixed flight configuration and the ground configuration, and wherein the actuator is also arranged to move the wing tip device from the moving flight configuration back to the fixed flight configuration. In the fixed flight configuration, the span may exceed an airport compatibility gate limit. In the ground configuration the span is reduced such that the span (with the wing tip device in the ground configuration) is less than, or substantially equal to, the airport compatibility gate limit.

The wing tip device may be rotatably mounted on a hinge at the tip of the fixed wing, such that the wing tip device may rotate about the hinge between the fixed flight and moving flight configurations. In arrangements in which the wing tip device is also moveable to the ground configuration, the wing tip device is preferably so moveable about this same hinge.

The hinge is preferably orientated non-parallel to the line-of flight direction. The hinge is preferably orientated such that the hinge at the trailing edge of the wing is further inboard than the hinge at the leading edge of the wing. The hinge is preferably orientated such that in the moving flight configuration, the mean incidence of the wing tip device is reduced. The hinge is preferably orientated substantially perpendicular to the swept mean chord axis of the wing. Such an arrangement has been found to be beneficial in terms of enabling a load reduction (in comparison with a hinge line that is orientated parallel to the line-of flight). Furthermore, such an orientation of hinge has been found to facilitate movement of the wing tip device to a stable load alleviating configuration. For example, when the hinge is in such an orientation, the wing tip device tends to move to a static-aeroelastically stable position even under purely aerodynamic loading. This orientation of hinge is therefore especially beneficial in combination with the restraining assembly. The orientation of the hinge may be chosen such that it acts to stabilize flutter.

Alternatively, the hinge may be orientated parallel to the line-of flight direction.

The wing tip device may be rotatable in an upwards direction and/or in a downwards direction.

Preferably, the upper and lower surfaces of the wing tip device are continuations of the upper and lower surfaces of the fixed wing in the fixed flight configuration. Preferably, the leading and trailing edges of the wing tip device are continuations of the leading and trailing edges of the fixed wind in the fixed flight configuration.

The method may further comprise holding the wing tip device in the fixed flight configuration using a restraining force, and releasing the restraining force to allow the wing tip device to adopt the moving flight configuration.

The wing may be placed in the moving flight configuration when the aircraft speed reaches a threshold just below the static aeroelastic divergence speed of the wing, or when the aircraft wing loading reaches a threshold just below the maximum wing loading value, or when the aircraft is flying at relatively low speed or altitude and a relatively high roll rate is required.

### BRIEF DESCRIPTION OF THE DRAWINGS

Embodiments of the disclosure herein will now be described with reference to the accompanying drawings, in which:

FIG. 1a shows a plan view of an aircraft with a forward swept wing and a forward swept folding wing tip device;

FIG. 1b shows the wing tip device of FIG. 1a in detail;

FIG. 2a shows a front view of the aircraft of FIG. 1a with the wing tip device in various configurations;

FIGS. 2b, 2c and 2d show the wing tip device of FIG. 2a in detail;

FIG. 3 shows a restraining assembly for the wing tip device;

FIG. 4 shows a normalised plot of wing bending moment and dynamic pressure for a forward swept wing and forward swept wing tip device with the wing tip device in the fixed and moving flight configurations;

FIG. 5 shows a plan view of an aircraft with an aft swept wing and a forward swept folding wing tip device; and

FIGS. 6a and 6b show front views of various further configurations of the wing tip device.

### DETAILED DESCRIPTION

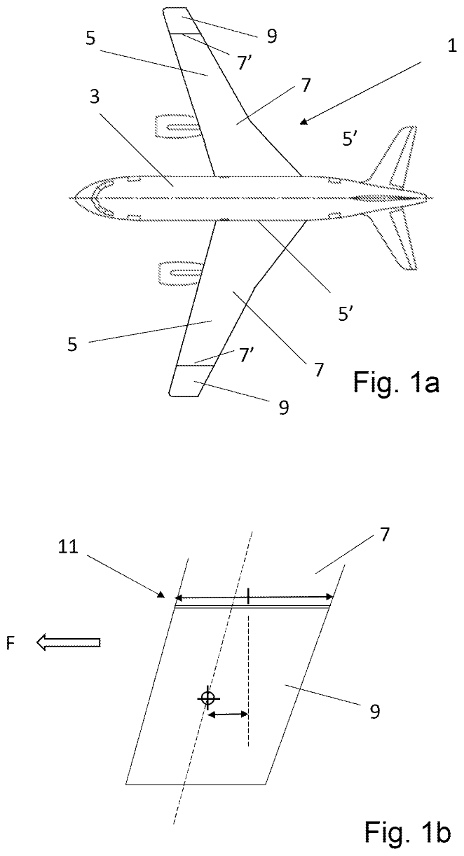

FIG. 1a is a plan view of an aircraft 1. The aircraft comprises a central fuselage 3 and two main wings 5 extending outwardly from respective wing roots 5′.

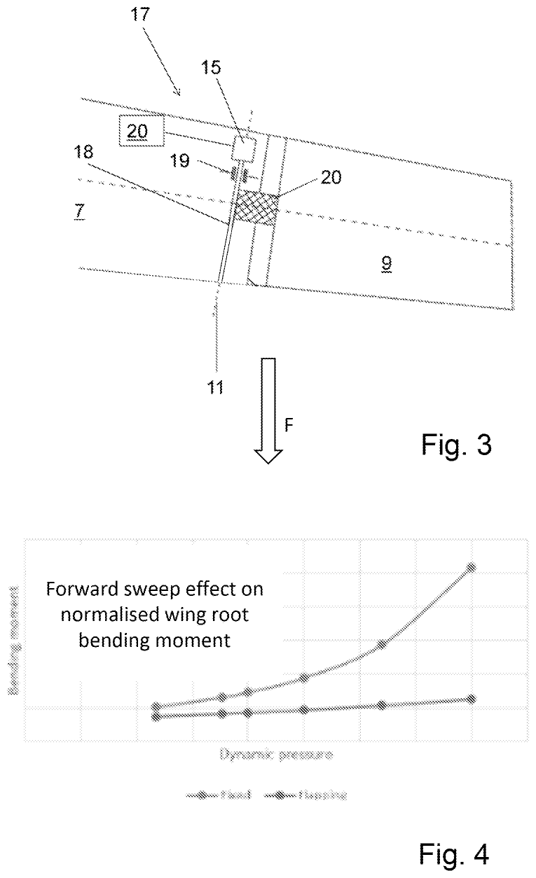

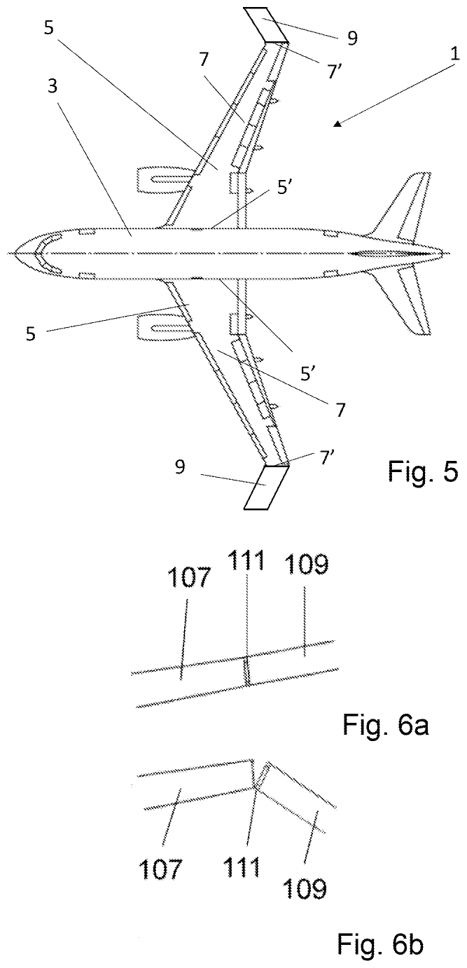

Each wing 5 comprises a fixed wing 7 extending from the root 5′ to the tip 7′ (shown in close up in FIG. 1b). At the tip 7′ of the fixed wing 7, the wing also comprises a moveable wing tip device 9, in the form of a planar wing tip extension. The wing tip device 9 is rotatable mounted about a hinge 11. This hinge 11, may be parallel to the line of flight direction F (as shown in FIGS. 1a, 1b and 5). The hinge 11 may alternatively be oriented non-parallel (or ‘flared’) to the line of flight direction (as shown in FIG. 3). The wing tip device 9 is forward swept.

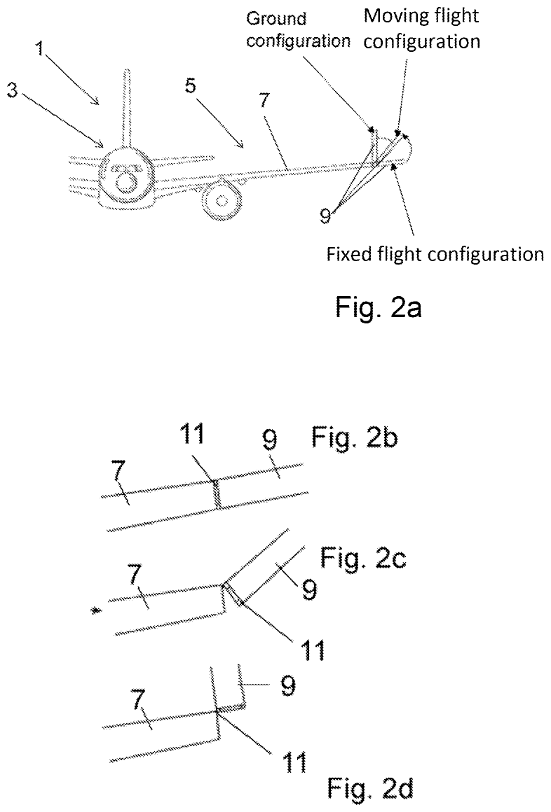

Referring now to FIGS. 2a to 2d, the wing tip device 9 is freely rotatable about the hinge 11 when in a moving flight configuration.

In the fixed flight configuration, the wing tip device 9 is fixed with respect to the fixed wing 7. The wing tip device 9 may be an extension of the fixed wing. Accordingly, the upper and lower surfaces of the fixed wing 5 may be continuous with the upper and lower surfaces of the wing tip device 9 (see FIG. 2b and the lowermost position in FIG. 2a). The leading and trailing edges of the fixed wing 5 may also be continuous with the respective leading and trailing edges of the wing tip device 9 (see FIGS. 1a and 1b). Such an arrangement is beneficial as it provides a relatively large wing span, thereby providing an aerodynamically efficient aircraft.

However, a large span can result in correspondingly large loads on the wing 5, particularly a large wing root bending moment, especially during high load events such a gusts or extreme maneuvers. This large wing root bending moment for a relatively large span wing is an issue for both aft swept and forward swept wings, and wings with zero sweep. The wing 5 must be sized to cope with these maximum loads, which can result in a relatively heavy wing, which may be prohibitive. The ability of the wing tip device 9 to move freely in the moving flight configuration (see FIGS. 2a and 2c) seeks to address that problem.

As discussed above, for forward swept wings the static aeroelastic divergence speed of the wing can be a particular issue if this is below the intended design speed of the aircraft. While adding stiffness to the wing structure may alleviate the problem of static aeroelastic divergence to enable the intended design speed to be achieved, the additional weight required would be prohibitive. For forward swept wings with a relatively large span, this problem is exacerbated. The ability of the wing tip device 9 to move freely in the moving flight configuration (see FIGS. 2a and 2c) seeks to address that problem.

Since the moveable wing tip device 9 is forward swept, the lift on the wing tip device will create a nose up twist at the tip of the fixed wing when the wing tip device is restrained in the fixed flight configuration, and this causes a relative nose down twist when the load on the wing tip device is diminished by releasing the wing tip device in the moving flight configuration. This relative nose down twist further reduces the loading on the fixed wing when in the moving flight configuration, which has benefits for both wing weight (for all fixed wing sweep angles, including zero) and the static aeroelastic divergence speed (forward swept fixed wing). Indeed, the relative nose down twist at the tip of the fixed wing 7 caused by releasing the forward swept wing tip device 9 to freely move has a particularly beneficial effect when employed on a forward swept fixed wing, due to the geometric coupling of wing bending and twist exhibited by forward swept wings. This will be explained more fully below.

As shown in FIG. 2c and the middle position in FIG. 2a, the wing tip device 9 is rotatable, upwards, such that the lower surfaces between the fixed wing 7 and the wing tip device 9, are no longer continuous with one another. Furthermore, if the hinge 11 is angled with respect to the streamwise direction (i.e. opposite the line of flight direction F), when the wing tip device 9 rotates upwardly its mean incidence is reduced.

In this moving flight configuration, the loads on the wing 5, generated by the wing tip device 9, are significantly reduced. The wing tip device 9 is released to this configuration during flight (described in more detail below). By providing this load alleviation function during flight, the maximum load the wing needs to be designed for may be reduced, and thus the wing 5 can be made relatively lightweight. Additionally, for a forward swept fixed wing, in this moving flight configuration the static aeroelastic divergence speed is increased by releasing the wing tip device 9 during flight.

The wing tip device 9 is also configurable to a ground configuration in which the wing tip device 9 is rotated yet further, to a substantially upright position (shown in FIG. 2d and the upright position in FIG. 2a). The wing tip device is moveable to this configuration when it is on the ground (described in more detail below). Once rotated to such a position, the span of the aircraft 1 is sufficient to meet airport compatibility gate limits. Thus, the aircraft 1 of the first embodiment can have a large span (exceeding gate limits) during flight, but is still able to comply with gate limits when on the ground.

Referring to FIG. 3, the aircraft 1 comprises a motor 15 connected to a drive shaft 18 that forms the shaft of the hinge 11. The wing tip device 9 is connected to the shaft 18 by a connecting piece 20. The motor 15 is arranged to rotate the wing tip device 9 between the fixed flight configuration (see FIG. 2b) and the ground configuration (see FIG. 2d) by actuation of the motor 15. This typically occurs shortly after landing to enable the aircraft to comply with airport gate limits. This movement also happens in reverse before take-off, once the aircraft has cleared the gate.

When the aircraft is flying and the wing tip device is in the fixed flight configuration, there tends to be a significant force on the wing tip (typically upwards). The wing tip device 9 may be restrained in the fixed flight configuration by an optional restraining assembly 17, or by applying a reverse torque using the motor 15, to actively hold down the wing tip device in the fixed flight configuration.

The restraining assembly 17 may comprise a brake 19 to selectively clamp against the shaft 18 to restrain its rotation. The restraining assembly 17 may be operable between a restraining mode (in which the brake 19 is deployed to brake the rotation of the shaft 18), and a releasing mode (in which the brake 19 is released to allow the shaft to freely rotate (and thus the rotation of the wing tip device 9). A clutch may be provided for decoupling the motor 15 from the shaft 18 to remove resistance on the shaft caused by the motor.

The default (passive) mode of the restraining assembly 17 may be the restraining mode in which the shaft 18 is braked and the wing tip device is fixed with respect to the fixed wing about the hinge in flight. When the wing tip device 9 is in the fixed flight configuration, the power to the restraining assembly 17 may be switched OFF (i.e. the assembly is passive) and the restraining assembly 17 is left with the shaft 18 braked. Such an arrangement is attractive as it ensures an active command (e.g. an ON signal) is required to move the wing tip device). Alternatively, the default mode of the restraining assembly 17 may be the wing tip device flapping mode in which the shaft 18 is unlocked to be substantially freely rotating, and the wing tip device is substantially freely rotating about the hinge in flight.

The restraining assembly 17, including the brake 19, may be controlled by a control module 20 of the Electronic Flight Control System (EFCS). The control module 20 is shown as a box in the schematic of FIG. 3.

When the wing tip device 9 is in the moving flight configuration, the motor 15 may be activated such that it rotates the wing tip device 9 back to the fixed flight configuration. Once in that position, the restraining assembly is switched back into restraining mode such that the brake is applied, and the motor is again returned to its passive state. Thus, the motor can be used not only to move the wing tip device between the fixed flight and ground configurations, but also from the moving flight configuration to the fixed flight configuration (but not from the fixed flight configuration to the moving flight configuration).

Allowing the wing tip device to substantially freely rotate bout the hinge has been found to be especially beneficial during low-speed operations (for example during take-off, climb, and/or landing). Due to system complexity, it tends to be difficult to integrate high-lift devices (such as slats) into a moveable wing tip device. The wing tip may therefore be prone to stall during low speed operations such as those indicated above. By moving the wing tip device to the moving flight configuration, the onset of stall may be alleviated (thereby avoiding the associated drag rise). This may assist the aircraft in meeting low speed requirements, especially for takeoff and climb. Thus, the control system may be configured to switch operation of the restraining assembly from the restraining mode to the releasing mode in response to a speed signal. The speed signal may indicate the aircraft is operating at low speed (for example the speed signal may indicate the speed is below a predetermined threshold).

The moving flight configuration may also be beneficial in reducing the flutter speed. In particular, when the restraining assembly adopts the releasing mode, and the wing tip device is in the moving flight configuration, the onset of flutter may be delayed. This is thought to be due to the flapping motion that the wing tip device may adopt when the restraining assembly is in the releasing mode. There is an EASA CS25 requirement that an aircraft is flutter free up to 115% times the dive speed (Vd) for a nominal condition or 100% times Vd for a failure condition. The moving flight configuration may be used to assist in suppressing flutter in this region between Vd and 1.15Vd. For example, the control system may be configured to switch operation of the restraining assembly from the restraining mode to the releasing mode in response to a speed signal indicating that the dive speed has been exceeded.

FIG. 4 is a graph showing the variation in wing bending moment (Y-axis) with dynamic pressure for two plots—the upper (light grey) line with the wing tip device fixed (fixed flight configuration) and the lower (dark grey) line with the wing tip device flapping (moving flight configuration)—for a forward swept fixed wing with a forward swept wing tip device. As can be seen, the bending moment on the wing increases exponentially as the dynamic pressure (aerodynamic wing loading) increases when the wing tip device is fixed. This exponent is related to the geometric coupling between wing bending and nose up twist exhibited by forward swept wings. Releasing the wing tip device to freely flap creates a near linear correlation between increasing bending moment and increasing dynamic pressure.

Therefore, the disclosure herein provides a “semi aeroelastic” hinge for the movable forward swept wing tip device, such that for nominal conditions the wing tip device would be locked flat for maximum aerodynamic efficiency, but as the divergence speed is approached, or if the aircraft enters a high load situation such as a gust, then the wing tip device would be released to flap freely. The semi aeroelastic hinge provides a way to enable a high aspect ratio forward swept wing by delaying the static aeroelastic divergence speed limitation, and by majorly offsetting the increase in loads and weight normally associated with forward swept wings.

When it is desired to return the wing from the moving flight configuration to the fixed flight configuration, e.g. after a gust load or when decreasing below a predetermined forward air speed, the control system may switch on the motor 15, which then pulls the wing tip device back down, e.g. from the position shown in FIG. 2c to the position shown in FIG. 2b. The control module 20 may switch the restraining assembly back to restraining mode, such that the hinge shaft 18 is braked, and the motor 15 is switched off.

The spanwise component of the airflow over the wing, created by the sweep angle, is directed inboard (towards the fuselage) in the case of a forward swept wing, whereas it is directed outboard in the case of an aft swept wing. On a wing with a folding wing tip device on a flared hinge the wing tip device will develop a larger front area when it rotates away from the fixed flight configuration to the moving flight configuration, which has an associated drag penalty. With a forward swept fixed wing, the inboard spanwise flow may mitigate some of the additional drag associated with the flapping wing tip device on the flared hinge, creating advantageous synergy between the forward swept fixed wing, the folding wing tip device and the flared hinge.

Furthermore, the inboard spanwise airflow on the forward swept wing tends to reduce the upwash on the outer wing section. Reduced upwash on the outer wing may reduce the sensitivity to wave drag and high speed buffet at higher aircraft weights.

In an alternative embodiment shown in FIG. 5, the fixed wing 7 of the aircraft 1 is an aft swept wing, i.e. the leading edge of the fixed wing has a aft sweep angle with respect to the spanwise direction. In all other respects, the aircraft 1 is identical to that described above with reference to FIGS. 1a to 4. The wing tip device has some of the same advantages of loads alleviation when released to be freely flapping as in the previous embodiment, and the forward swept wing tip device provides an advantageous relative nose down pitch on the tip of the fixed wing when the wing tip device is released. However, the further benefits associated specifically with a forward swept fixed wing are no longer realized.

In an alternative embodiment, as shown in FIGS. 6a and 6b, the hinge 111 may allowing for both upward and downward rotation of the wing tip device 109 to the moving flight configuration (only the downward rotation being illustrated in FIG. 6b, and the upward rotation being as per FIG. 2c and optionally also 2d). The hinge 111 may be a double hinge to allow for both upward and downward rotation of the wing tip device. Such an arrangement enables both positive-g and negative-g loads to be alleviated, for example. The hinge may be applicable to both the forward swept and aft swept fixed wing 107 embodiments described above.

In the moving flight configuration, the load on the wing tip may be reduced or substantially eliminated. Such an arrangement has been found to be especially beneficial when the aircraft is undergoing roll. In particular, since the lift forces at the tips of the wings are alleviated, they tend not to act against (i.e. they tend not to damp) the rolling motion. This may enable the aircraft to be more responsive when undergoing roll (or as responsive as an aircraft with a correspondingly shorter wing span). The restraining assembly may adopt the releasing mode during a roll maneuver in order to mitigate the roll damping effect caused by the wing tips. In other words, the wing tip devices may be released to freely flap when the aircraft initiates a roll maneuver, with the wing tip devices rotating in opposite directions. For example, in a port side roll, the left (port) wing tip device may freely rotate upwardly and the right (starboard) wing tip device may freely rotate downwardly. This causes the overall lift distribution to be restricted inboard and any roll damping effect from the load on the tips is largely removed.

The control module of the Electronic Flight Control System (EFCS) may place the restraining assembly into the releasing mode when it detects that a roll is being performed (for example in response to opposing movements of the ailerons). The control module of the EFCS may also be arranged to receive a signal relating to the speed of the aircraft and when the aircraft is at a relatively low speed (e.g. during climb). This could open the possibility of releasing actively the wing tip devices at low speed/altitude e.g. if high roll rate required (thanks to reduced roll damping from the flapping).

Where the word ‘or’ appears this is to be construed to mean ‘and/or’ such that items referred to are not necessarily mutually exclusive and may be used in any appropriate combination.

Although the disclosure herein has been described above with reference to one or more preferred embodiments, it will be appreciated that various changes or modifications may be made without departing from the scope of the disclosure herein as defined in the appended claims.

It should be understood that modifications, substitutions and alternatives may be apparent to one of ordinary skill in the art and can be made without departing from the scope of the disclosed invention(s). This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft wing for an aircraft having a longitudinal axis, the wing extending in a spanwise direction perpendicular to the aircraft longitudinal axis, wherein the wing comprises a fixed wing with a tip, and a wing tip device moveably mounted at the tip of the fixed wing, wherein the fixed wing has an upper surface and a lower surface, and the wing tip device has an upper surface, a lower surface and a leading edge, and the wing tip device is operable between:
a fixed flight configuration for use during flight, wherein the upper and lower surfaces of the wing tip device are substantially fixed relative to the upper and lower surfaces of the fixed wing, and wherein the leading edge of the wing tip device is forward swept with respect to the spanwise direction; and
a moving flight configuration for use during flight, wherein the wing tip device is free to move relative to the fixed wing such that at least one of the upper and lower surfaces of the wing tip device is moved away from the respective surface of the fixed wing.

2. The aircraft wing according to claim 1, comprising a restraining assembly operable between a restraining mode in which the wing tip device is held in the fixed flight configuration using a restraining force, and a releasing mode in which the restraining force on the wing tip device is released, such that the wing tip device is able to adopt the moving flight configuration, and the wing tip device is entirely free to rotate when the restraining assembly is in the releasing mode.

3. The aircraft wing according to claim 1, wherein the fixed wing has a leading edge, and the leading edge of the fixed wing is forward swept with respect to the spanwise direction in the fixed flight configuration.

4. The aircraft wing according to claim 3, wherein the leading edge of the fixed wing has a sweep angle with respect to the spanwise direction, and the leading edge of the wing tip device has a sweep angle with respect to the spanwise direction, and the sweep angle of the fixed wing is identical to the sweep angle of the wing tip device adjacent the tip of the fixed wing.

5. The aircraft wing according to claim 1, wherein the fixed wing has a leading edge, and the leading edge of the fixed wing is aft swept with respect to the spanwise direction.

6. The aircraft wing according to claim 1, wherein the wing tip device has a center of lift, and the tip of the fixed wing has a chord, and wherein a location of the center of lift is forward of a location of 50% chord of the tip of the fixed wing.

7. The aircraft wing according to claim 1, wherein the wing tip device is also operable in a ground configuration for use during ground-based operations, in which ground configuration the wing tip device is moved away from the flight configuration such that the span of the aircraft wing is reduced, wherein the aircraft comprises an actuator arranged to move the wing tip device between the fixed flight configuration and the ground configuration, and wherein the actuator is also arranged to move the wing tip device from the moving flight configuration back to the fixed flight configuration.

8. The aircraft wing according to claim 1, wherein the wing tip device is rotatably mounted on a hinge at the tip of the fixed wing, such that the wing tip device can rotate about the hinge between the fixed flight and moving flight configurations.

9. The aircraft wing according to claim 8, wherein the hinge is orientated non-parallel to a line of flight direction.

10. The aircraft wing according to claim 8, wherein the hinge is orientated parallel to a line of flight direction.

11. The aircraft wing according to claim 1, wherein the upper and lower surfaces of the wing tip device are continuous with the upper and lower surfaces of the fixed wing when in the fixed flight configuration.

12. A method of operating an aircraft wing for an aircraft having a longitudinal axis, the wing extending in a spanwise direction perpendicular to the aircraft longitudinal axis and comprising a fixed wing with a tip, and a wing tip device moveably mounted at the tip of the fixed wing, wherein the fixed wing has an upper surface and a lower surface, and the wing tip device has an upper surface, a lower surface and a leading edge, the method comprising:
placing the wing tip device in a fixed flight configuration during flight in which the upper and lower surfaces of the wing tip device are fixed with respect to the upper and lower surfaces of the fixed wing, and in which the leading edge of the wing tip device is forward swept with respect to the spanwise direction; and
placing the wing tip device in a moving flight configuration during flight, wherein the wing tip device is freely moveable relative to the fixed wing such that at least one of the upper and lower surfaces of the wing tip device is move away from the respective surface of the fixed wing.

13. The method according to claim 12, wherein the method further comprises holding the wing tip device in the fixed flight configuration using a restraining force, and releasing the restraining force to allow the wing tip device to adopt the moving flight configuration.

14. The method according to claim 12, wherein the wing tip device has a center of lift, and the tip of the fixed wing has a chord, and wherein a location of the center of lift is forward of a location of 50% chord of the tip of the fixed wing, such that an aerodynamic load on the wing tip device creates a forward twist moment about the 50% chord of the tip of the fixed wing during flight.

15. The method according to claim 12, wherein the fixed wing has a leading edge, and the leading edge of the fixed wing is forward swept with respect to the spanwise direction in the fixed flight configuration.

16. The method according to claim 12, wherein the wing is placed in the moving flight configuration when the aircraft speed reaches a threshold just below a static aeroelastic divergence speed of the wing, or when the aircraft wing loading reaches a threshold just below a maximum wing loading value, or when the aircraft is flying at relatively low speed or altitude and a relatively high roll rate is required.
